(19) United States
(12) Patent Application Publication
(10) Pub. No.: US 2017/0367152 A1
(43) Pub. Date: Dec. 21, 2017

(54) HEATER AND HEATING DEVICE

(71) Applicants: TOSHIBA TEC KABUSHIKI KAISHA, Tokyo (JP); TOSHIBA HOKUTO ELECTRONICS CORPORATION, Hokkaido (JP)

(72) Inventors: Osamu TAKAGI, Chofu Tokyo (JP); Kazuhiko Kikuchi, Yokohama Kanagawa (JP); Chie Miyauchi, Odawara Kanagawa (JP)

(21) Appl. No.: 15/624,926

(22) Filed: Jun. 16, 2017

(30) Foreign Application Priority Data
Jun. 20, 2016 (JP) 2016-121402
May 16, 2017 (JP) 2017-097321

(51) Int. Cl. H05B 6/54; F24H 9/20; H05B 6/60; H05B 6/62

(52) U.S. Cl. CPC H05B 6/54; H05B 6/62; F24H 9/2064; H05B 6/60

(57) ABSTRACT

A heater according to an embodiment generally includes a base, a protrusion, a heat generating layer, a first protective layer, and an electrode layer. The protrusion protrudes from the base. The heat generating layer is disposed on the protrusion. The first protective layer is disposed on the heat generating layer. The electrode layer is disposed on the base to drive the heat generating layer.

### CROSS-REFERENCE TO RELATED APPLICATIONS

This application is also based upon and claims the benefit of priority from Japanese Patent Application No, 2016-121402, filed on Jun. 20, 2016 and Japanese Patent Application No, 2017-97321, filed on May 16, 2017; the entire contents of which are incorporated herein by reference.

### FIELD

Embodiments described herein relate generally to a technique for protecting an electrode layer in a heater.

### BACKGROUND

A fixing device that interposes a sheet with a pressure roller and a belt has been known in the art. In this fixing device, a plate-shaped heater is in contact with an inner surface of the belt to heat the belt. A heat generating layer is disposed on a substrate of the heater along a longer-side direction of the heater. Electrode layers for driving the heat generating layer are disposed on both sides of the heat generating layer in a shorter-side direction of the heater. A protective layer is disposed on the heat generating layer.

In such a conventional heater, when the protective layer is abraded due to the sliding of the belt on the protective layer, there is a risk of leading to the contact of the electrode layer with the belt and thereby causing a short.

### DESCRIPTION OF THE DRAWINGS

FIG. 1 is a schematic view of an image forming apparatus;

FIG. 2 is a diagram illustrating a configuration example of a fixing device;

FIG. 3 is a plan view illustrating an arrangement of resistive heat generating layers and electrode layers in a plane heater;

FIG. 4 is a cross-sectional view illustrating a configuration of the plane heater; and

FIG. 5 is a diagram illustrating another configuration example of a fixing device.

### DETAILED DESCRIPTION

A heater according to an embodiment generally includes a base, a protrusion, a heat generating layer, a first protective layer, and an electrode layer. The protrusion protrudes from the base. The heat generating layer is disposed on the protrusion. The first protective layer is disposed on the heat generating layer. The electrode layer is disposed on the base to drive the heat generating layer.

A heating device according to an embodiment generally includes a pressure member, a belt, and a heater. The belt and the pressure member together interpose and convey a sheet therebetween. In addition, the belt heats the sheet so that an image on the sheet is fixed onto the sheet. The heater faces the pressure member via the belt and heat the belt. The heater includes a base, a protrusion protruded from the base, a heat generating layer disposed on the protrusion, a protective layer disposed on the heat generating layer, and an electrode layer disposed on the base to drive the heat generating layer.

Embodiments will now be described below with reference to the drawings.

### First Embodiment

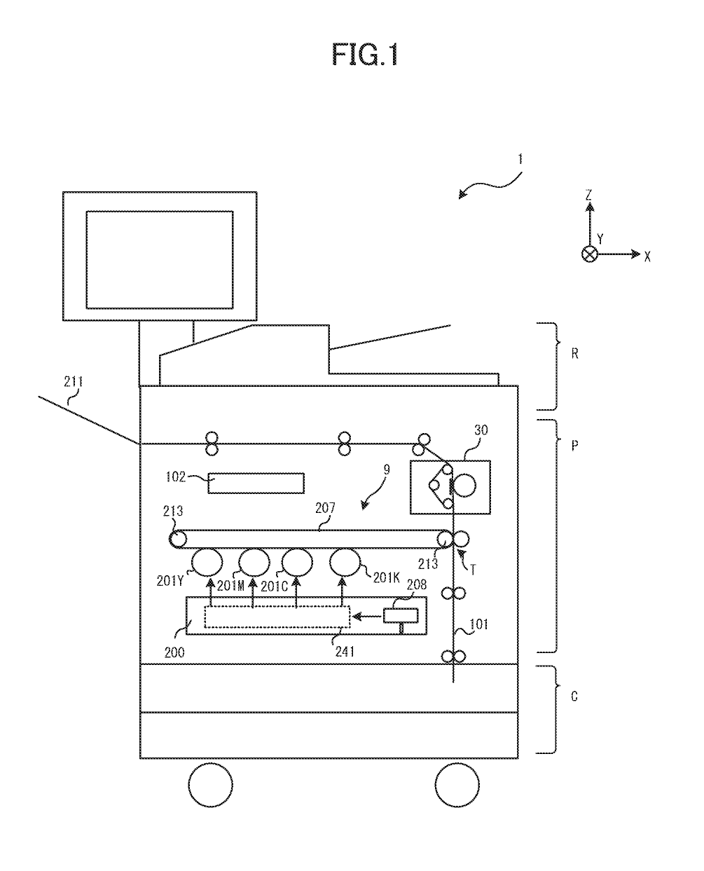

FIG. 1 is a schematic view of an image forming apparatus 1. The image forming apparatus 1 includes a reading unit R, an image forming unit P, and a paper cassette unit C. The reading unit R reads a document sheet placed on a platen with a CCD (charge-coupled device) image sensor, for example, so as to convert an optical signal into digital data. The image forming unit P acquires a document image read in the reading unit R or print data from an external personal computer, and forms and fixes a toner image on a sheet.

The image forming unit P includes a laser scanning section 200 and photoconductor drums 201Y, 201M, 201C, and 201K. The laser scanning section 200 includes a polygon mirror 208 and an optical system 241. On the basis of image signals for colors of yellow (Y) , magenta (M) , cyan (C), and black (K), the laser scanning section 200 irradiates the photoconductor drums 201Y to 201K to provide an image to be formed on the sheet.

The photoconductor drums 201Y to 201K retain respective color toners supplied from a developing device (not shown) according to the above-described irradiated locations. The photoconductor drums 201Y to 201K sequentially transfer the retained toner images onto a transfer belt 207. The transfer belt 207 is an endless belt. The transfer belt 207 conveys the toner image to a transfer location T by the rotary driving of rollers 213.

A conveyance path 101 conveys a sheet stocked in the paper cassette unit C through the transfer location T, a fixing device 30 (heating device), and an output tray 211 in this order. The sheet stocked in the paper cassette unit C is conveyed to the transfer location T while being guided by the conveyance path 101. The transfer belt 207 then transfers the toner image onto the sheet at the transfer location T.

The sheet having the toner image formed on a surface thereof is conveyed to the fixing device 30 while being guided by the conveyance path 101. The fixing device 30 causes the toner image to penetrate into the sheet and fix therein by the heating and fusion of the toner image. This can prevent the toner image on the sheet from being disturbed by an external force. The conveyance path 101 conveys the sheet having the fixed toner image to the output tray 211 and ejects the sheet from the image forming apparatus 1.

A controller 102 is a unit for controlling devices and mechanisms in the image forming apparatus 1 in a centralized manner. The controller 102 includes, for example, a central processor such as a central processing unit (CPU), and volatile and non-volatile memories. According to an embodiment, a central processor controls the devices and the mechanisms in the image forming apparatus 1 by executing programs stored in memories. Alternatively, the controller 102 may implement part of the functions as a circuit.

A configuration including the sections used for conveying an image (toner image) to be formed to the transfer location T and transferring the image onto the sheet is referred to as a transfer unit 9.

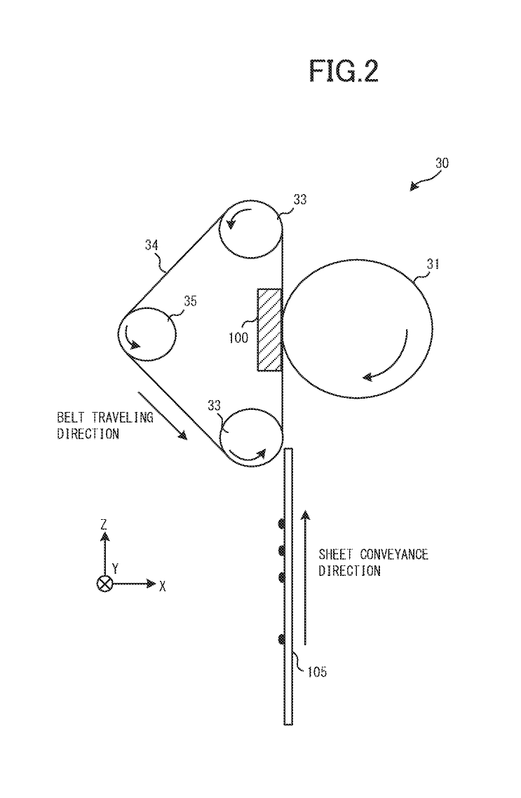

FIG. 2 is a diagram illustrating a configuration example of the fixing device 30.

The fixing device 30 includes a plate-shaped plane heater 100, and an endless belt 34 suspended by a plurality of rollers. The fixing device 30 also includes driving rollers 33 for suspending the endless belt 34 and rotary-driving the endless belt 34 in a given direction. The fixing device 30 also includes a tension roller 35 for providing tension as well as suspending the endless belt 34. The fixing device 30 also includes a pressure roller 31 (pressure member) having an elastic layer formed on a surface thereof.

The plane heater 100 is disposed at a position facing the pressure roller 31 with the endless belt 34 interposed therebetween. The plane heater 100 is pressed against the pressure roller 31. The plane heater 100 is in contact with an inner surface of the endless belt 34 to heat the endless belt 34. The endless belt 34 heats the sheet while interposing the sheet together with the pressure roller 31 at a contact portion (nip portion) therebetween. The endless belt 34 and the pressure roller 31 together convey the sheet downstream in a sheet conveyance direction. The endless belt 34 fixes the toner image on the sheet onto the sheet. In other words, the endless belt 34 heats the sheet and thereby fixes the image on the sheet onto the sheet while sandwiching and conveying the sheet together with the pressure roller 31.

The endless belt 34 includes a base layer (Ni/SUS/PI: a thickness of 60 to 100 μm), an elastic layer (Si rubber: a thickness of 100 to 300 μm), and a release layer (PFA: a thickness of 15 to 50 μm) sequentially provided from the side in contact with the plane heater 100. The thicknesses and materials of such layers are provided by way of example only.

The endless belt 34 may utilize the rotation of the pressure roller 31 as its source of motive power.

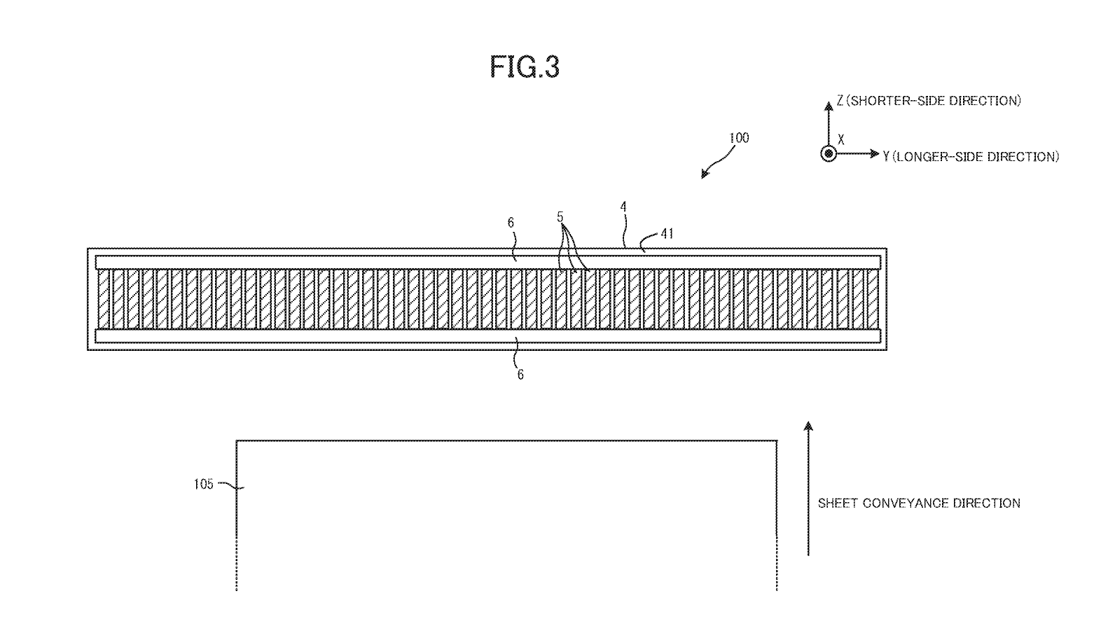

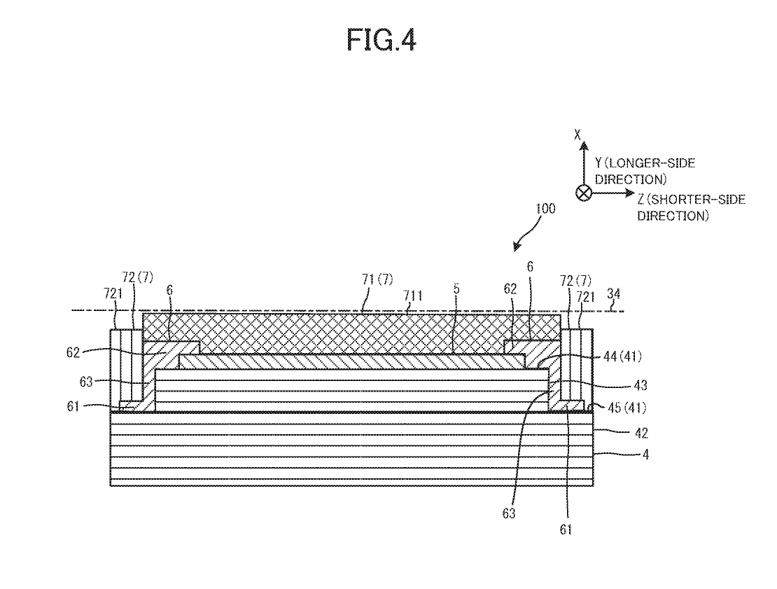

FIG. 3 is a plan view illustrating an arrangement of resistive heat generating layers 5 and electrode layers 6 in the plane heater 100. Hereinafter, a direction corresponding to the sheet conveyance direction as well as a shorter-side direction of the plane heater 100 (base unit 42 (FIG. 4)) is defined as a Z direction (second direction). A direction corresponding to a sheet width direction as well as a longer-side direction of the plane heater 100 (base unit 42) is defined as a Y direction (first direction). The Y direction is perpendicular to the Z direction. A direction corresponding to a direction toward the pressure roller 31 as well as a vertical direction of the base unit 42 is defined as an X direction. The X direction is perpendicular to the Z direction and the Y direction.

The plane heater 100 includes a ceramic substrate 4 (layered body) extending in the Y direction. The substrate 4 is disposed in such a manner as to face a surface of a conveyed sheet 105 via the endless belt 34. The resistive heat generating layers 5 and the electrode layers 6 are provided on a surface 41 of the substrate 4 in contact with the endless belt 34.

The plurality of resistive heat generating layers 5 are provided at intervals in the Y direction. The resistive heat generating layer 5 generates heat when energized. The resistive heat generating layer 5 is elongated in the Z direction in a planar view.

The electrode layers 6 are provided at both ends of the resistive heat generating layers 5 in the Z direction. The electrode layers 6 apply a DC or AC voltage to the resistive heat generating layers 5 so as to drive the resistive heat generating layers 5. The electrode layer 6 is made of aluminum, for example. Wiring is connected to each of the electrode layers 6. The electrode layers 6 are connected to a control circuit for controlling the electrode layers 6 via the wiring.

Part of the electrode layer 6 is deposited on the resistive heat generating layers 5 (see FIG. 4). The electrode layer 6 maybe divided in the Y direction for each resistive heat generating layer 5 or for several resistive heat generating layers 5 in order to drive them individually.

FIG. 4 is a cross-sectional view illustrating a configuration of the plane heater 100.

The substrate 4 includes the base unit 42 extending in the Y direction, and a step forming unit 43 (protruding unit) extending in the Y direction. The step forming unit 43 protrudes from the base unit 42 in the X direction and extends in the Y direction. The base unit 42 and the step forming unit 43 are separate units and are green sheets each having a different thickness in the X direction. The green sheets are heat-resistant ceramics.

After the green sheet constituting the base unit 42 and the green sheet constituting the step forming unit 43 are stacked on each other, those green sheets are baked while being pressurized from the both sides thereof in the X direction. In this manner, the both green sheets can be joined to each other. The thickness of the base unit 42 is greater than the thickness of the step forming unit 43.

Note that the base unit 42 may be a single layer, or the base unit 42 and the step forming unit 43 in FIG. 4 may be integrally formed. The base unit 42 and the step forming unit 43 may be formed by cutting the both ends of the substrate in the Z direction along the Y direction.

The surface 41 of the substrate 4 where the step forming unit 43 is present includes: a first surface 44 corresponding to an upper surface of the step forming unit 43; and second surfaces 45 disposed on both sides of the first surface 44 in the Z direction and positioned lower than the first surface 44. The resistive heat generating layers 5 are provided on the first surface 44, and the electrode layer 6 is provided on each of the second surfaces 45. The electrode layer 6 is partially deposited on the resistive heat generating layers 5.

The electrode layers 6 are disposed on both sides of the step forming unit 43 in the Z direction and extend in the Y direction. As mentioned previously, the electrode layer 6 may be divided in the Y direction so that the resistive heat generating layers 5 are divided individually or into several groups in order to control the resistive heat generating layers 5 individually or for each group. While the electrode layers 6 are disposed on both sides of the step forming unit 43 in the Z direction, portions of the electrode layers 6 connected to the resistive heat generating layers 5 are disposed on the step forming unit 43.

The electrode layer 6 includes a first electrode layer 61, a second electrode layer 62, and a connecting unit 63.

The first electrode layer 61 is disposed on the base unit 42.

The second electrode layer 62 is disposed on the step forming unit 43. Part of the second electrode layer 62 is deposited on one end of the resistive heat generating layers 5 in the Z direction and connected to that end.

The connecting unit 63 extends in the X direction to connect between an end of the first electrode layer 61 positioned closer to the center of the base unit 42 in the Z direction and an end of the second electrode layer 62 positioned closer to an end of the base unit 42 in the Z direction.

A protective layer 7 is provided on the resistive heat generating layers 5 and the electrode layers 6. The protective layer 7 is made of SiO₂, for example. The endless belt 34 slides on the protective layer 7. The protective layer 7 prevents the endless belt 34 from being in contact with the resistive heat generating layers 5 and the electrode layers 6.

The protective layer 7 includes a first protective layer 71 and second protective layers 72. The first protective layer 71 is provided on the resistive heat generating layers 5. The second protective layer 72 is a sealing layer for the electrode layer 6 and provided on the electrode layer 6 present on the second surface 45. Specifically, the first protective layer 71 is provided on the resistive heat generating layers 5 and on the second electrode layers 62 and the connecting units 63 in the electrode layers 6. The second protective layer 72 is provided on the first electrode layer 61.

A height of a top surface 721 of the second protective layer 72 from the base unit 42 is lower than a height of a top surface 711 of the first protective layer 71 from the base unit 42. Note that the top surface 721 of the second protective layer 72 may be flush with the top surface 711 of the first protective layer 71.

In the above-described embodiment, the position of the resistive heat generating layers can be elevated by the step forming unit 43, thus allowing the resistive heat generating layers 5 to be positioned higher than the electrode layers 6. Accordingly, the electrode layer 6 (the first electrode layer 61) can be provided at a position lower than that of the resistive heat generating layer 5 in this embodiment. Therefore, as compared to a case where the resistive heat generating layers 5 and the electrode layers 6 are on surfaces having the same height, the present embodiment can prevent the exposure of the electrode layer 6 (the first electrode layer 61) when the protective layer 7 is diminished due to abrasion. Thus, the electrode layer 6 can be protected more reliably.

In this embodiment, the position of the resistive heat generating layers 5 can be elevated by the step forming unit 43, thus allowing the resistive heat generating layers 5 to be positioned higher than the electrode layers 6. Accordingly, in this embodiment, the height of the top surface 711 of the first protective layer 71 on the resistive heat generating layers 5 can be easily made higher than or equal to the height of the top surface 721 of the second protective layer 72 on the electrode layer 6. In this embodiment, this enables the endless belt to be in contact with the first protective layer 71, thereby preventing the endless belt 34 from being lifted up from the first protective layer 71. Therefore, the present embodiment can achieve excellent heat transfer efficiency from the resistive heat generating layers 5 to the endless belt 34.

Since the endless belt 34 is in contact with the first protective layer 71 in this embodiment, the abrasion of the second protective layer 72 can be reduced as compared to the conventional technique in which the endless belt 34 is lifted up from the first protective layer 71. Thus, the present embodiment can prevent the electrode layer 6 from being brought into contact with the endless belt 34 due to the abrasion of the second protective layer 72. Consequently, a short due to the contact between the electrode layer 6 and the endless belt 34 can be prevented from occurring.

### Second Embodiment

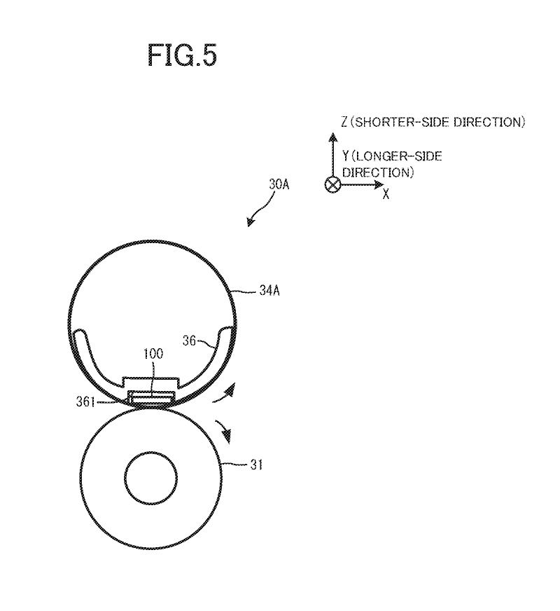

FIG. 5 is a diagram illustrating a configuration example of a fixing device 30A.

A film guide 36 has a semi-cylindrical shape and accommodates the plane heater 100 in a recess 361 provided on an outer periphery thereof.

A fixing film 34A (belt) is a rotating body having an endless shape. The fixing film 34A is fitted over the outer periphery of the film guide 36. The fixing film 34A is interposed between the film guide 36 and the pressure roller 31 and driven by the rotation of the pressure roller 31.

The plane heater 100 is in contact with the fixing film 34A to heat the fixing film 34A.

A sheet having a toner image formed thereon is conveyed to a place between the fixing film 34A and the pressure roller 31. The fixing film 34A heats the sheet and thereby fixes the toner image on the sheet onto the sheet.

In each of the above embodiments, the step forming unit 43 has been described as an example of the protruding unit. The protruding unit, however, is not limited to a rectangular shape in cross section. The protruding unit may have any shape in cross section as long as the protruding unit protrudes from the base unit 42 in the X direction and includes a heat generating layer on an upper surface thereof. For example, the protruding unit may have an upper surface with rounded opposite ends in the Z direction while having a cross-sectional shape similar to that of the step forming unit 43. Alternatively, corners made by the protruding unit and the base unit 42 may be rounded.

In the above embodiments, the fixing devices 30 and 30A have been described as examples of the heating device. The heating device, however, may perform a decolorization treatment for decolorizing an image on a sheet by heating the sheet. In this case, the image is assumed to be formed with a decolorable colorant, which is decolorized when heated. Alternatively, the heating device may be employed for purposes other than the heat treatment of a sheet. The heating device may be employed for a treatment for uniformly heating and drying a panel, for example.

As described above, the embodiments can protect the electrode layer of the heater.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. A heater comprising:
a base;
a protrusion protruded from the base;
a heat generating layer disposed on the protrusion;
a first protective layer disposed on the heat generating layer; and
an electrode layer disposed on the base and configured to drive the heat generating layer.

2. The heater according to claim 1, comprising a second protective layer disposed on the electrode layer and having a top surface positioned lower than a top surface of the first protective layer.

3. The heater according to claim 1, wherein the protrusion is formed integrally with the base.

4. The heater according to claim 1, wherein the protrusion is formed separately from the base.

5. The heater according to claim 1, wherein
the protrusion extends in a longer-side direction of the base, and
the electrode layer is disposed on each side of the protrusion in a shorter-side direction of the base.

6. The heater according to claim 5, wherein
the electrode layer comprises:
a first electrode layer disposed on the base; and
a second electrode layer disposed on the protrusion and connected to the first electrode layer and an end of the heat generating layer in the shorter-side direction.

7. The heater according to claim 6, comprising a second protective layer disposed on the first electrode layer, wherein
the first protective layer is disposed on the heat generating layer and the second electrode layer.

8. The heater according to claim 7, wherein a top surface of the second protective layer is positioned lower than a top surface of the first protective layer

9. The heater according to claim 1, wherein
the protrusion extends in a longer-side direction of the base, and
a plurality of the heat generating layers are disposed at intervals in the longer-side direction.

10. A heating device comprising:
a pressure member;
a belt configured to interpose and convey a sheet together with the pressure member and to heat the sheet and thereby fix an image on the sheet onto the sheet; and
a heater disposed to face the pressure member via the belt and configured to heat the belt, the heater comprising:
a base;
a protrusion protruded from the base;
a heat generating layer disposed on the protrusion;
a protective layer disposed on the heat generating layer; and
an electrode layer disposed on the base and configured to drive the heat generating layer.
